(19) United States
(12) Patent Application Publication
(10) Pub. No.: US 2016/0154383 A1
(43) Pub. Date: Jun. 2, 2016

(54) PROGRAMMABLE TIMER

(71) Applicant: Joo Sul KIM, Goyang-si, Gyeonggi-do (KR)

(72) Inventor: Joo Sul KIM, Goyang-si, Gyeonggi-do (KR)

(21) Appl. No.: 14/905,248

(22) PCT Filed: Jul. 18, 2013
(86) PCT No.: PCT/KR2013/006429

§ 371 Date: Jan. 14, 2016

(51) Int. Cl. G04G 15/00; G04G 9/00

(52) U.S. Cl. CPC G04G 15/006; G04G 9/00

(57) ABSTRACT

A programmable timer is disclosed which may simultaneously display AM and PM reservation times and may display the reservation times in the way of matching with the time display method of an ordinary clock to enable a user to easily identify the reservation times. The programmable timer includes a panel unit (300) that includes a time and channel display unit 340 in which a looped AM reservation time display region (342b) and a looped PM reservation time display region (342c) are arranged on concentric circles; and a control unit (600) dividing set reservation times into a morning time and an afternoon time, assigning the morning time to the AM reservation time display region (342b), assigning the afternoon time to the PM reservation time display region (342c), and controlling a coloring state of the time and channel display unit 340 to enable each reservation time display region (342b or 342c) to be colored and displayed by an assigned time.

### TECHNICAL FIELD

The present disclosure relates to a programmable timer, and more particularly, to a programmable timer that may divide and display reservation times into morning (AM) and afternoon (PM) times.

### BACKGROUND ART

In general, a timer is a kind of a switch that is attached to various electrical or electronic devices to be automatically opened and closed. The operation mode of the timer includes a momentary reservation mode and a period reservation mode. The momentary reservation mode includes a mode in which an ON state is maintained simultaneously with setting, a change to an OFF state is performed when a certain length of time elapses or when a certain time comes, and a change to the ON state is performed when a certain length of time elapses or when a certain time comes. In addition, the period reservation mode includes a mode in which the ON sate is maintained for a set time and then a return to the OFF state is performed, when a certain time comes in the OFF state, and a mode in which the OFF sate is maintained for a set time and then a return to the ON state is performed, when a certain time comes in the ON state.

An example of a typical reservation time display method is displaying only reservation states within 12 hours before and after the current time. Such a method has limitations in that it is difficult to identify afternoon 12-hour reservation details at a look in the morning and it is difficult to identify morning 12-hour reservation details at a look in the afternoon. That is, because it is difficult to see daily 24-hour reservation states at a look, a user has inconvenience in identifying reservation states.

As another example of a typical reservation time display method, there is also a method in which a single circle is divided into morning 12 hours and afternoon 12 hours around 360□ based on the central point as in a mechanical timer that uses mechanical pins. That is, the same times in the morning and in the afternoon are represented on facing points. However, such a time display method makes it difficult for people who are familiar with ordinary clocks, to easily identify reserved times, because the method is different from ordinary clocks that display hours around 360 degrees based on the central point and alternately display morning and afternoon times stagger the display.

Thus, there is a need for the development of a timer that may simultaneously display each of AM and PM reservation times and display reservation times in the way of seeing an ordinary clock.

### DISCLOSURE OF THE INVENTION

### Technical Problem

Embodiments provide a programmable timer that simultaneously display AM and PM reservation times. Embodiments also provide a programmable timer that may display the reservation times in the way of matching with the time display method of an ordinary clock to enable a user to easily identify the reservation times.

### Technical Solution

In one embodiment, a programmable timer that

displays a reservation time includes

a panel unit (300) that includes a time and channel display unit 340 in which a looped AM reservation time display region (342b) and a looped PM reservation time display region (342c) are arranged on concentric circles; and

a control unit (600) dividing set reservation times into a morning time and an afternoon time, assigning the morning time to the AM reservation time display region (342b), assigning the afternoon time to the PM reservation time display region (342c), and controlling a coloring state of the time and channel display unit 340 to enable each reservation time display region (342b or 342c) to be colored and displayed by an assigned time.

The panel unit (300) may further include a setting time manipulation button unit (310) that has a looped configuration and has buttons having numbers 1 to 12 that are arranged in a same way as numbers on a clock plate around the AM reservation time display region (342b) and the PM reservation time display region (342c).

The panel unit (300) may further include a current time display unit (341) that is disposed at a center of the AM reservation time display region (342b) and the PM reservation time display region (342c) to display a current time.

A digital time or an analog time that includes an hour hand and a minute hand may be displayed on the current time display region (341).

The AM reservation time display region (342b) and the PM reservation time display region (342c) on the time and channel display unit (340) may be segmented into multiples of 6 or 12.

### ADVANTAGEOUS EFFECTS

The programmable timer according to an embodiment has an effect in that it divides and displays set reservation times into AM reservation times and PM reservation times in the way of matching with a clock to enable a user to identify set reservation times at a look.

The programmable timer according to an embodiment provides an effect in that it is possible to simultaneously display a set value within a segment when setting each of AM and PM reservation times.

### BRIEF DESCRIPTION OF THE DRAWINGS

FIG. 1 schematically shows how to display a reservation time by a timer according to an embodiment.

FIG. 2 is a block diagram that represents the internal configuration of a programmable timer according to an embodiment.

FIG. 3 is a diagram that represents an exemplary embodiment of a programmable timer according to an embodiment.

FIG. 4 schematically shows a reservation time display method by a programmable timer according to an embodiment.

FIG. 5 schematically shows how to display a reservation state by a programmable timer according to an embodiment.

### MODE FOR CARRYING OUT THE INVENTION

In the following, the detailed description of an exemplary embodiment is described with reference the accompanying drawings. When describing the inventive concept, detailed descriptions related to relevant known functions or configurations will be ruled out in order not to unnecessarily obscure subject matters of the inventive concept.

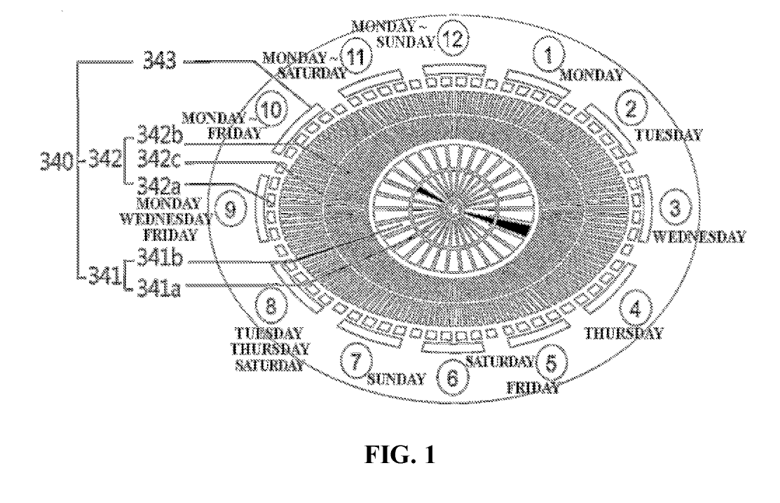

FIG. 1 schematically shows how to display a reservation time by a timer according to an embodiment. Referring to FIG. 1, a programmable timer according to an embodiment includes a panel unit 300 that includes a setting time manipulation button unit 310 and a time and channel display unit 340. The setting time manipulation button unit 310 includes buttons having numbers 1 to that are arranged in a looped style. Although the number buttons may be implemented by using a press button switch, the embodiment is not limited thereto.

Since the number buttons of the setting time manipulation button unit 310 are arranged in the same positions of numbers on a clock plate that is familiar to people, people may identify reservation times that are displayed in the form of a pie and the current time displayed in the form of the hands of a clock by the time and channel display unit 340, in the way of matching the clock.

A reservation time display region 342, a current time display region 341, and a channel display region 343 are set on the time and channel display unit 340. Although the time and channel display unit 340 may be implemented by means of a display device, such as an LCD, the embodiment is not limited thereto.

The reservation time display region 342 includes a looped AM reservation time display region 342b, a looped PM reservation time display region 342c, and a looped minute-based reservation display region 342a, that are arranged on concentric circles. Although FIG. 1 shows that the AM time display unit 342b is positioned on the inward side, the PM time display unit 342c is positioned at the center, and the minute-based reservation display region 342a is positioned on the outward side, the embodiment is not limited thereto.

Since numbers 1 to 12 on the number buttons on the time and channel display unit 340 represent the time, it is possible to display morning 12 hours by means of the looped AM reservation time display region 342 and display afternoon 12 hours by means of the PM reservation time display region 342c, and it is possible to simultaneously display the AM reservation time display region 342b and the PM reservation time display region 342c to display up to 24-hour reservation times.

The AM reservation time display region 342b and the PM reservation time display region 342c are in the form of looped bands arranged on the concentric circles, and are colored to indicate reservation times. The length of a colored region corresponds to a reservation time.

Although the AM reservation time display region 342b and the PM reservation time display region 342c on the time and channel display unit 340 include a plurality of segments that are divided into multiples of 6 or 12, the embodiment is not limited thereto. Dividing into multiples of 6 or 12 means dividing a time unit, such as morning/afternoon, one hour, or the like into at least 6 or 12. For example, a morning time (12 hours) are divided into 12 segments at a one-hour interval or one hour is divided into 6 segments at a 10-minute interval.

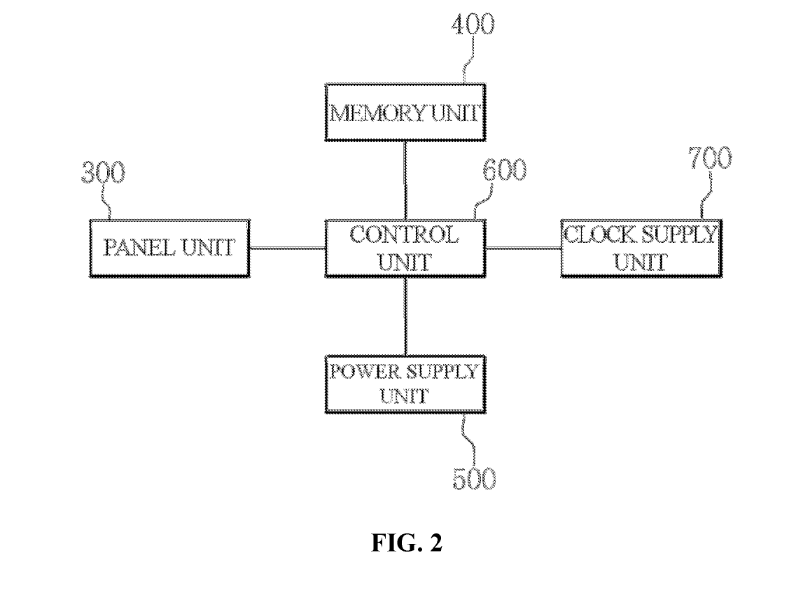

The control unit 600 (see FIG. 2) divides set reservation times into a morning time and an afternoon time, assigns the morning time to the AM reservation time display region 342b, assigns the afternoon time to the PM reservation time display region 342c, and the minute-based reservation state of a specific hour that also needs to display a minute unit to the minute-based reservation display region 342a. Also, the control unit 600 (see FIG. 2) controls the light-emitting state of the time and channel display unit 340 so that the time assigned to each reservation time display region is displayed according to the arrangement of the setting time manipulation button unit 310.

The time and channel display unit 340 further includes a current time display region 341 that displays the current time. The current time display region 341 is disposed at the center of the setting time manipulation button unit 310.

The current time display region 341 may display the current time in an analog clock style but also display it in a digital clock style.

FIG. 2 is a block diagram that represents the internal configuration of a programmable timer according to an embodiment.

Referring to FIG. 2, the programmable timer according to an embodiment includes the panel unit 300, a memory unit 400, a power supply unit 500, a control unit 600, and a clock supply unit 700.

The panel unit 300 enables a reservation time to be roughly set through selection by month, day, and day of the week or displays a set reservation time.

The memory unit 400 stores timer setting information that is manipulated through an operating program and panel unit 300 that is provided to enable a timer to be set by month, day, and day of the week.

The power supply unit 500 supplies power to the panel unit 300, the memory unit 400, the control unit 600, and the clock supply unit 700.

The control unit 600 stores, in the memory unit 400, time setting information set through selection by month, day, and day of the week through the panel unit 300, and enables selective time setting by month, day, and day of the week according to the stored timer setting information.

The clock supply unit 700 supplies a clock required for the operation of the control unit 600 to enable the control unit 600 to selectively control timer setting by month, day, and day of the week according to corresponding timer setting information.

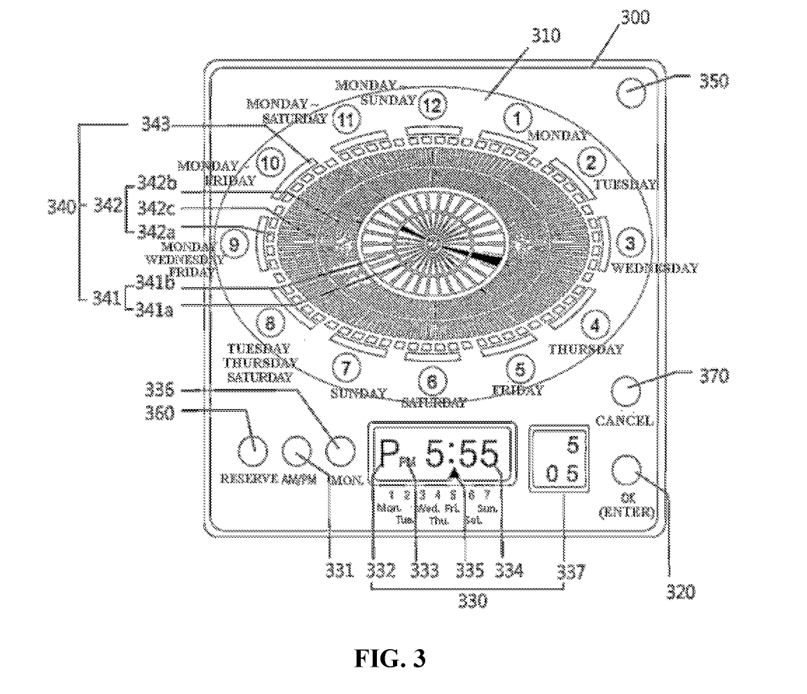

FIG. 3 is a diagram that represents an exemplary embodiment of a programmable timer according to an embodiment.

The panel unit 300 is to manipulate a timer setting time or discern manipulated details and the panel unit 300 includes the setting time manipulation button unit 310, a timer setting time input button 320, a setting time display unit 330, an AM/PM manipulation button 331, the time and channel display unit 340, a mode selection button 350, a reservation request button 360, and a timer setting cancellation button 370. Each of the components 310, 320, 331, 336, and 350 to 370 include press buttons but the embodiment is not limited thereto. A timer setting day of the week display region 335 of the setting time display unit 330 may include a 7-segment display but the embodiment is not limited thereto.

The setting time manipulation button unit 310 includes 12 number buttons on which numbers 1 to 12 are displayed, respectively. Monday/Wednesday/Friday, Tuesday/Thursday/Saturday, Monday to Friday, Monday to Saturday, and Monday to Sunday are respectively marked for five buttons 8 to 12 other than seven buttons 1 to 7 for which a day of the week is also marked, among 12 buttons that make up the setting time manipulation button unit 310.

The setting time display unit 330 displays AM or PM manipulated through the AM/PM manipulation button 331 when manipulating a timer setting time, a setting reservation time, and performs display to be capable of recognizing the timer setting time sequentially manipulated through the setting time manipulation button unit 310. The setting time display unit 330 includes a setting mode display region 332, an AM/PM display region 333, a setting time display region 334, the timer setting day of the weak display region 335, and a month/day display region 337.

The AM/PM manipulation button 331 is manipulated to select AM or PM when setting the timer time.

The setting mode display region 332 displays a corresponding mode selected by a user.

The AM/PM display region 333 displays AM or PM according to the manipulation of the AM/PM manipulation button 331.

The setting time display region 334 may display a timer setting time that is sequentially manipulated through the setting time manipulation button unit 310 when manipulating the timer setting time. The programmable timer according to an embodiment may be programmed so that the current time may also be displayed through the manipulation of a specific button in addition to displaying the timer setting time on the setting time display region 334, when a user desires.

The timer setting day of the week display region 335 includes the timer setting day of the week display region 335 that displays day of the week selected by manipulating 12 buttons of the setting time manipulation button unit 310 for which a day of the week is marked, after the initial manipulation of the reservation request button 360.

Also, the month/day setting button 336 may be manipulated so that it is possible to request the input of month or day by using the setting time manipulation button unit 310, and the month/day display region 337 displays the month and day selected through the manipulation of the 12 buttons on the setting time manipulation button unit 310 after the initial manipulation of the month/day setting button 336. That is, in the case that month is input, the month is input by using 12 numbers on the setting time manipulation button unit 310, and the numbers represent January to December. In the case that day is input, the day is input by the combination of numbers 1 to 10, in the case that 31th is designated, numbers 3 and 1 are sequentially input, and in the case that 20th is designated, numbers 2 and 10 are sequentially input.

Thus, the above-set values are sequentially displayed on the month/day display region 337, and in the case of March, 20th, the set values 3 and 20 are displayed on the month/day display region 337.

For the manipulation of the components 310, 320, 331, 336, and 350 to 370, the panel unit 300 may be implemented as a touch screen. Typically, the touch screen is an interface device designed so that a control unit may recognize a contact part to execute a command, when there is a direct contact between a body, such as a finger or a ballpoint-shaped touch pen and the screen.

The touch screen may be implemented by using various techniques. As an example, the touch screen may be a pressure-sensitive screen in which a row of sensors responding to pressure applied to the surface of the screen is tightly installed, to recognize positions with coordinates when the pressure is applied. As another example, the touch screen may be a capacitive screen in which charges are charged on the surface of the screen, and sensors are installed therearound to sense the lost degree of charges when there is a contact, and recognize where there is a contact. However, the operating technique of the touch screen is not limited thereto.

When a timer is set, a mode to be set is first designated with the mode selection button 350, then the reservation request button 360, the setting time control button 310, and the timer setting time input button 320 are used to sequentially input a corresponding timer setting value, and lastly, the timer setting time input button 320 is input so that a required setting operation ends.

When the reservation request button 360 is pressed, it is notified that the input of the timer setting time value starts, and when the timer setting time input button 320 is lastly pressed, the timer setting time value is input. The input timer setting time value make ups timer setting time information in the summary. The timer setting time information is stored in the memory unit 400 by the control unit 600.

1. Mode Selection and Timer Setting Time Input

The programmable timer according to an embodiment may implement various types of timer setting that a user desires, including the current time, a channel, month/day, day of the week, hour/minute setting.

A rough timer setting sequence and manipulation unit is as follows.

1) Mode selection: mode selection button 350 and timer setting time input button 320.

2) Current time setting: mode selection button 350, number buttons on setting time manipulation button unit 310, AM/PM manipulation button 331, and timer setting time input button 320.

3) Reservation time and channel setting: reservation request button 360, number buttons on setting time manipulation button unit 310, AM/PM manipulation button 331, and timer setting time input button 320.

Firstly, the mode selection is performed as follows.

The mode selection button 350 is to select various types of timer setting modes.

Examples of the timer setting mode that may be implemented by the programmable timer according to an embodiment include a current time setting mode, a month/day-hour/minute mode, a day of the week-hour/minute mode, a channel-hour/minute mode, a channel-month/day-hour/minute mode, and a channel-day of the week-hour/minute mode.

When the mode selection button 350 is pressed once, it is possible to sequentially select the current time setting mode, the month/day-hour/minute mode, the day of the week-hour/minute mode, the channel-hour/minute mode, the channel-month/day-hour/minute mode, and the channel-day of the week-hour/minute mode.

The sequence of the mode that may be selected according to the pressing of the mode selection button 350 is preset and the control unit 600 recognizes the selection state (e.g., the number of times that pressing is performed) of the mode selection button 350 to display a corresponding mode on the setting mode display region 332.

When it is displayed on the setting mode display region 332 that a desired mode may be selected, a user presses the timer setting time input button 320 to select a corresponding mode. The control unit 600 recognizes the mode selected by the user with reference to the selection state of the mode selection button 350 and the timer setting time input button 320.

Next, the current time setting is performed as follows.

The current time setting mode is used when the current time is input or modified.

In the current time setting mode, timer setting details are input by means of the buttons having numbers 1 to 12 that are installed on the setting time manipulation button unit 310, and the timer setting time input button 320.

When a user designates the current time setting mode, the control unit 600 recognizes the current time setting mode with reference to the selection state of the mode selection button 350 and stands by.

Since in the current time setting mode, it is programmed to recognize that the firstly input number button on the setting time manipulation button unit 310 inputs month and the secondly and thirdly manipulated buttons input day, month and day are input with buttons 1 to 12 on the setting time manipulation button unit 310.

In this case, since it is programmed to display, on the month/day display region 337, time information on month, day that corresponds to selected buttons, a user inputs a month/day value while checking it and then manipulates the timer setting time input button 320 to complete the input and the control unit 600 stands by inputs related to AM/PM, hour, minute.

The user may select AM or PM through the manipulation of the AM/PM manipulation button 331. The selected information is displayed on the AM/PM display region 333.

Also, the control unit recognizes that the number button on the setting time manipulation button unit 310 that is input firstly by a user inputs hour and the secondly and thirdly manipulated number buttons input minute. Thus, the user manipulates the AM/PM manipulation button 331, manipulates the number buttons 1 to 12 on the setting time manipulation button unit 310 to input hour and minute, and then manipulates the timer setting time input button 320 to complete inputting hour and minute.

As such, when the timer setting time input button 320 is manipulated after the inputting of the current time, the control unit 600 stores input current time information in the memory unit 400 and enables the information to be displayed by an hour hand and minute hand of an analog type on the current time display region 341. In addition, the control unit 600 displays the current time on the setting time display unit 330.

Next, the reservation time and channel setting is performed as follows.

As described earlier, the timer includes a term reservation type timer and a momentary reservation type timer. The term reservation type timer requires the start and end times of a reservation and the momentary reservation type timer requires only one of the start or end times. For example, when there is a need to set a reservation time from 1:10 PM, Tuesday (start time) to 1:10 PM, Wednesday (end time) by using the term reservation type timer, there is a need to sequentially input the start time (1:10 PM, Tuesday) and the end time (1:10 PM, Wednesday). However, in the momentary reservation, only 1:10 PM, Tuesday or 1:10 PM, Wednesday needs to be input.

In the case that a term reservation according to an example above by using the programmable timer according to an embodiment is performed, there is only need to sequentially input reservation request button 360→day of the week selection (Tuesday)→timer setting time input button 320, AM/PM selection (PM)→hour input (1 o'clock)→minute input (10 minutes)→reservation request button 360→day of the week (Wednesday)→timer setting time input button 320, AM/PM selection (PM)→hour input (1 o'clock)→minute input (10 minutes)→timer setting time input button 320.

Also, in the case that the momentary reservation is performed by using the programmable timer according to an embodiment, there is only need to sequentially input reservation request button 360→day of the week selection (Tuesday)→timer setting time input button 320, AM/PM selection (PM)→hour input (1 o'clock)→minute input (10 minutes)→timer setting time input button 320.

In this case, the input request button 360 is used to notify the start of timer reservation setting. Also, the input request button 360 is used to distinguish the start time from the end time.

The timer setting time input button 320 is also used to identify a channel, month/day, day of the week, and hour/minute that make up a timer setting time. In particular, the lastly used timer setting time input button 320 also performs a role in notifying that the inputting of the timer time setting is completed.

Although in the following, descriptions are provided based on the term reservation mode, details to be provided herein may also be equally applied to the momentary reservation mode.

When other mode selection excluding the current time setting mode is completed, the user presses the reservation request button 360 to notify the control unit 600 that the inputting of timer setting information starts.

Then, timer setting details are input by means of the buttons having numbers 1 to 12 that are installed on the setting time manipulation button unit 310, and the timer setting time input button 320.

The inputting sequence of the timer setting information according to the selected mode is predetermined and the control unit 600 recognizes the inputting of the timer setting information according to the set input sequence.

For example, the user sequentially inputs AM/PM, hour, minute, and the timer setting input button 320 in a hour/minute mode, and the control unit 600 recognizes the firstly input number as hour and the lastly input number as minute.

The control unit 600 displays, on the setting time display region 334, time information corresponding to the timer setting information input by the user so that the user may recognize the input timer setting information.

Before the designation of hour/minute, the user may manipulate the AM/PM manipulation button 331 to designate AM/PM.

The control unit 600 recognizes the pressed state of the AM/PM manipulation button 331 and displays a corresponding state on the AM/PM display region 333.

When the user checks details displayed on the setting time display region 334 and the AM/PM display region 333 and lastly manipulates the timer setting time input button 320, set hour/minute, AM/PM information are determined as the timer setting information.

The control unit 600 stores the determined timer setting information in the memory unit 400.

The setting cancellation button 370 is provided in order to cancel a set timer setting state.

A reservation time setting method according to each mode is performed as follows.

(1) Hour/Minute Mode

The hour/minute mode is to set a start time and an end time by the designation of hour/minute, and in the designation of hour/minute, AM/PM, hour and minute are input and the timer setting time input button 320 is pressed.

For example, when there is a need to set a reservation time from 1:10 AM (start time) to 1:10 PM (end time), there is a need to sequentially input reservation request button 360→AM/PM selection (AM)→hour input (1 o'clock)→minute input (10 minutes)→reservation request button 360→AM/PM selection (PM)→hour input (1 o'clock)→minute input (10 minutes)→timer setting time input button 320.

(2) Month/Day-Hour/Minute Mode

The month/day-hour/minute mode is to set a start time and an end time by the designation of month/day-hour/minute.

In the designation of month/day, month and date are input and the timer setting time input button 320 is manipulated. In the designation of hour/minute, AM/PM, hour and minute are sequentially input and the timer setting time input button 320 is manipulated.

For example, when designating “ March 20th”, the numbers 3, 2 and 10 on the setting time manipulation button unit 310 are sequentially designated and the timer setting time input button 320 is manipulated.

When designating “03:20 PM”, the AM/PM manipulation button 331 is manipulated to select PM, the numbers 3, 2, and 10 on the setting time manipulation button unit 310 are sequentially designated, and the timer setting input button 320 is manipulated.

When there is a need to set reservation times from e.g., 1:10 AM, March 10th (start time) to 2:20 PM, March 12nd (end time), reservation request button 360→month input (March)→day input (10th)→timer setting time input button 320→AM/PM selection (AM)→hour input (1 o'clock)→minute input (10 minutes)→reservation request button 360→month input (March)→day input (12th)→timer setting time input button 320→AM/PM selection (AM)→hour input (2 o'clock)→minute input (20 minutes)→timer setting time input button 320 are sequentially input.

(3) Day of the Week-Hour/Minute Mode

When the mode selection button 350 is manipulated to select a day of the week-hour/minute mode, the selected mode is displayed on the setting mode display region 332 of the setting time display unit 330, and a user recognizing it manipulates the timer setting time input button 320 and then selects at least one desired start day of the week of twelve buttons which make up the setting time manipulation button unit 310 and for which a day of the week is also marked.

In the case that it is assumed that the user has pressed button 1 for which Monday is also marked and button 3 for which Wednesday is also marked, the selected Monday and Wednesday are colored and displayed on the timer setting day of the week display region 335 of the setting time display unit 330. Also, in order to enable a user to easily recognize the selected days of the week, numbers and days of the week corresponding to the numbers are lengthwise marked under the timer setting day of the week display region 335.

Also, the timer setting day of the week is also displayed on the timer setting day of the week display region 335 of the setting time display unit 330 so that the user may recognize.

Among the number buttons, buttons 1 to 7 correspond to Monday to Sunday, respectively, button 8 corresponds to “Tuesday, Thursday, Saturday”, button 9 corresponds to “Monday, Wednesday, Friday”, button 10 corresponds to “Monday to Friday”, button 11 corresponds to “Monday to Saturday”, and button 12 corresponds to “Monday to Sunday”.

When designating “Monday”, the number 1 of the setting time manipulation button unit 310 is designated and the timer setting time input button 320 is pressed.

Referring to FIG. 3, it may be seen that a corresponding day of the week may be displayed under the number button so that a user may recognize the corresponding state of a day of the week relative to the number button.

For example, when there is a need to set reservation times from 1:10 PM, Tuesday (start time) to 1:10 PM, Wednesday (end time), reservation request button 360→day of the week selection (Tuesday)→timer setting time input button 320, AM/PM selection (PM)→hour input (1 o'clock)→minute input (10 minutes)→reservation request button 360→day of the week (Wednesday)→timer setting time input button 320, AM/PM selection (PM)→hour input (1 o'clock)→minute input (10 minutes)→timer setting time input button 320 are sequentially input.

When there is a need to simultaneously reserve from 1:10 AM (start time) to 1:10 PM (end time) on three days, Tuesday, Thursday and Saturday,

reservation request button 360→day of the week selection (Tuesday, Thursday, Saturday)→timer setting time input button 320, AM/PM selection (AM)→hour input (1 o'clock)→minute input (10 minutes)→reservation request button 360→day of the week (Tuesday, Thursday, Saturday)→timer setting time input button 320, AM/PM selection (PM)→hour input (1 o'clock)→minute input (10 minutes)→timer setting time input button 320 are sequentially input.

(4) Channel-Hour/Minute Mode

The timer may select up to 24 channels. It is possible to select 24 channels through programming through which it is possible to select channels 1 to 12 when a channel-day of the week-hour/minute mode is selected with the mode selection button 350 and then any button of the setting time manipulation button unit 310 is selected without manipulating the AM/PM button, and it is possible to select any one of channels 13 to 24 when PM is selected with the AM/PM selection button and the any button of the setting time manipulation button unit 310 is selected.

After the inputting of the channel, the timer setting time input button 320 is manipulated, AM/PM, hour, and minute are sequentially input and the timer setting time input button 320 is manipulated. When designating “channel 3”, the number 3 of the setting time manipulation button unit 310 is designated and the timer setting time input button 320 is pressed.

It is possible to use twelve buttons making up the setting time manipulation button unit 310 to set, by channel, the hour/minute of a start time and length of operation time of a device associated with the programmable timer according to the embodiment.

In this example, it is assumed that a user already knows the mapping of a channel and a corresponding electronic device, but programming may also be performed to present a mapping state through the panel unit 300.

For example, when there is a need to set reservation times for channel 3 from 1:10 AM (start time) to 1:10 PM (end time), reservation request button 360→channel selection (channel 3)→timer setting time input button 320, AM/PM selection (AM)→hour input (1 o'clock)→minute input (10 minutes)→reservation request button 360→AM/PM selection (PM)→hour input (1 o'clock)→minute input (10 minutes)→timer setting time input button 320 are sequentially input.

(5) Channel-Month/Day-Hour/Minute Mode

A channel is input, the timer setting time input button 320 is manipulated, month/day is input, the timer setting time input button 320 is manipulated, AM/PM, hour, minute are sequentially input, and the timer setting time input button 320 is manipulated.

For example, when there is a need to set reservation times for channel 3 from 1:10 AM, March 10th (start time) to 1:10 PM, March 11th (end time),

reservation request button 360→channel selection (channel 3)→timer setting time input button 320, month input (March)→day input (10th), timer setting time input button 320→AM/PM selection (AM)→hour input (1 o'clock)→minute input (10 minutes)→reservation request button 360→month input (March)→day input (11th)→timer setting time input button 320→AM/PM selection (PM)→hour input (1 o'clock)→minute input (10 minutes)→timer setting time input button 320 are sequentially input.

(6) Channel-Day of the Week-Hour/Minute Mode

In the programmable timer according to the embodiment, it is possible to identify 12 to 24 channels and selectively apply a user's desired day of the week to a corresponding channel to set the timer.

When the mode selection button 350 is manipulated to select and manipulate a channel-day of the week-hour/minute mode, the selected mode displayed on the setting mode display region 332 of the setting time display unit 330, a user recognizing it manipulates the reservation request button 360 and then manipulate twelve buttons making up the setting time manipulation button unit 310 for which numbers are marked and the AM/PM manipulation button 331 to be capable of selecting a channel corresponding to the manipulated number.

Then, when the timer setting time input button 320 is manipulated, the control unit 600 may identify, by channel, a mode to set the timer according to an input day of the week and set up to 24 timer times. The subsequent day of the week setting and time setting are the same as before.

Likewise, when setting time according to a day of the week of various devices with one timer, the programmable timer according to the embodiment may identify 24 channels and apply a corresponding channel to a changed device without requiring to newly set a timer time each time a device is changed.

For example, when there is a need to set reservation times for channel 3 from 1:10 AM, Tuesday (start time) to 1:10 PM, Wednesday (end time),

reservation request button 360→channel selection (channel 3)→timer setting time input button 320, day of the week input (Tuesday), timer setting time input button 320→AM/PM selection (AM)→hour input (1 o'clock)→minute input (10 minutes)→reservation request button 360→day of the week input (Wednesday)→timer setting time input button 320→AM/PM selection (PM)→hour input (1 o'clock)→minute input (10 minutes)→timer setting time input button 320 are sequentially input.

How the input reservation button 360 and the timer setting input button 320 are used to input the timer setting time has been described above. The input reservation button 360 is used in order to notify the start of timer reservation setting and also used in order to distinguish the start time from the end time. The timer setting time input button 320 is used to identify a channel, month/day, day of the week, and hour/minute that makes up a timer setting time. The timer setting input button 320 lastly used performs a role in notifying the end of the inputting of the timer setting time in most cases.

Alternatively, it may also be considered that the start of the inputting of the timer setting time is notified by the initial manipulation of the timer setting input button 320, month/day, day of the week, hour/minute making up the timer setting time are sequentially input according to a pre-designated order and then the end of the inputting of the timer setting time is notified by the last manipulation of the timer setting input button 320.

In particular, when mode selection is completed, a user notifies the control unit 600 of the start of the inputting of the timer setting time by the initial manipulation of the timer setting time input button 320.

Then, the timer setting time is input by means of the buttons having numbers 1 to 12 that are installed on the setting time manipulation button unit 310, the AM/PM manipulation button 331, and the timer setting time input button 320.

The inputting sequence of the timer setting information according to the selected mode is predetermined and the control unit 600 recognizes the inputting of the timer setting information according to the set input sequence.

In e.g. the hour/minute mode, the user sequentially inputs AM/PM, hour, and minute and inputs the timer setting time input button 320. The control unit 600 recognizes the firstly input number as hour and the lastly input number as minute.

When for example, March, 20th is input in the month/day-hour/minute mode and the user sequentially presses buttons 3, 2, and 10 among buttons of the setting time manipulation button unit 310, the control unit recognizes the firstly input number 3 as month and recognizes the secondly and thirdly input numbers 2 and 10 as day.

The user notifies the control unit 600 of the end of the inputting of the timer setting time by the last manipulation of the timer setting time input button 320.

The control unit 600 recognizes the timer setting time input from when the start of the inputting of the timer setting time is instructed by the initial manipulation of the timer setting time input button 320 to when the completion of the inputting of the timer setting time is instructed by the last manipulation of the timer setting time input button 320. In addition, the control unit 600 sets the recognized timer setting time as a timer reservation time when the completion of the inputting of the timer setting time is instructed by the timer setting time input button 320.

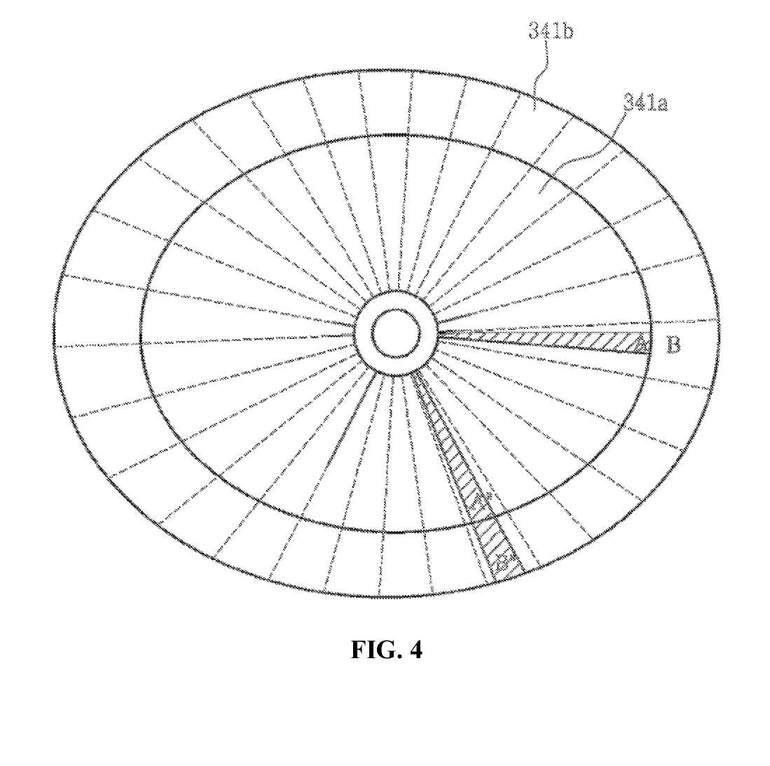

FIG. 4 schematically shows a current time display method by a programmable timer according to an embodiment.

The time and channel display unit 340 includes the current time display region 341 that displays the current time, the reservation time display region 342 that displays a reservation time set with the timer, a setting reservation time manipulated through the setting time manipulation button unit 310, and the channel display region 343.

Also, the reservation time display region 342 is divided into an AM reservation time display region 342b that displays morning times, a PM reservation time display region 342c that displays afternoon times, and a minute-based reservation display region 342a. In addition, the current time display region 341 is divided into an hour display region 341a that together displays an hour hand and a minute hand, and a minute display region 341b that displays only the minute hand.

When e.g., current time 3:25 is displayed, only portion A that corresponds to 3'oclock of the hour display region 341a is colored and portions A″ and B″ that correspond to 25 minutes are together colored.

The current time and the reservation time are displayed in an analog type on the current time display region 341 and the reservation time display region 342. In addition, a setting time is displayed in a digital type on the setting time display region 334 displayed on the setting time display unit 330.

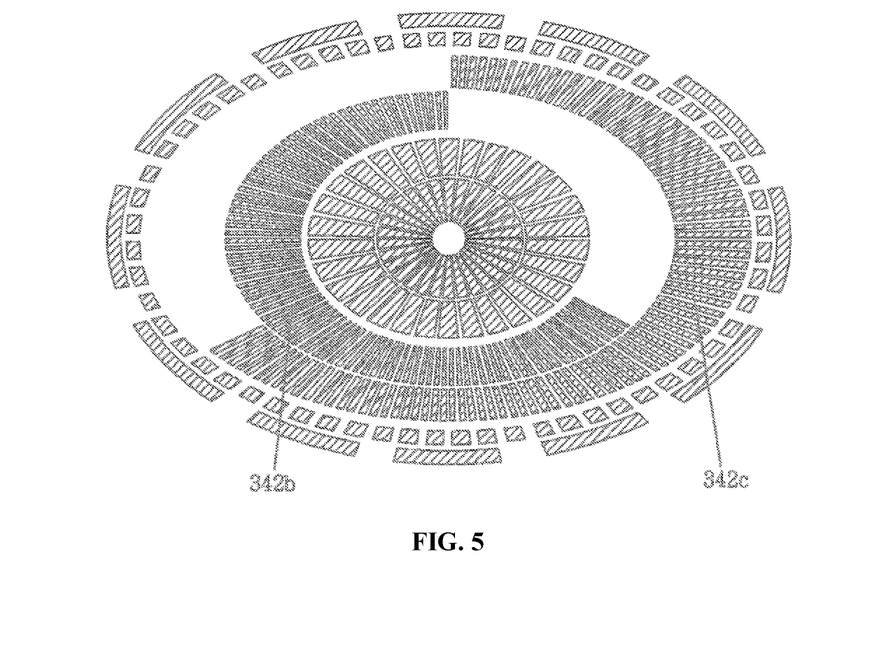

FIG. 5 schematically shows a reservation setting time display method by a programmable timer according to an embodiment.

When a reservation time is set from e.g., 04:00 AM to 08:00 PM, 04:00 AM to noon is displayed on the AM reservation time display region 342b and noon to 08:00 PM is displayed on the PM reservation time display region 342c as shown in FIG. 5.

As such, the programmable timer according to the embodiment enables a user to easily discern AM and PM time information when displaying timer reservation information.

Although the embodiment describes a timer that divides reservation times into an AM reservation time and a PM reservation time to display a separate display region, a person skilled in the art should understand that such a technical feature may also be equally applied to other devices that display a reservation time.

As such, although the present disclosure and the accompanying drawings disclose exemplary embodiments and specific terms are used, the embodiments and the terms are only used in a general meaning to easily describe the technical features of the inventive concept and help the understanding of the inventive concept and the scope of the inventive concept is not limited thereto. It is obvious to a person skilled in the art that other variations that are based on the technical spirit of the inventive concept, as well as the disclosed embodiments may be implemented.

1. A programmable timer that displays a reservation time, the programmable timer comprising:
a panel unit (300) that comprises a time and channel display unit 340 in which a looped AM reservation time display region (342b) and a looped PM reservation time display region (342c) are arranged on concentric circles; and
a control unit (600) dividing set reservation times into a morning time and an afternoon time, assigning the morning time to the AM reservation time display region (342b), assigning the afternoon time to the PM reservation time display region (342c), and controlling a coloring state of the time and channel display unit 340 to enable each reservation time display region (342b or 342c) to be colored and displayed by an assigned time.

2. The programmable timer according to claim 1, wherein the panel unit (300) further comprises a setting time manipulation button unit (310) that has a looped configuration and has buttons having numbers 1 to 12 that are arranged in a same way as numbers on a clock plate around the AM reservation time display region (342b) and the PM reservation time display region (342c).

3. The programmable timer according to claim 1, wherein the panel unit (300) further comprises a current time display unit (341) that is disposed at a center of the AM reservation time display region (342b) and the PM reservation time display region (342c) to display a current time.

4. The programmable timer according to claim 2, wherein the panel unit (300) further comprises a current time display region (341) that is disposed at a center of the setting time manipulation button unit (310) to display a current time.

5. The programmable timer according to claim 1, further comprising a current time display region (341) that that is disposed at a center of the AM reservation time display region (342b) and the PM reservation time display region (342c) and comprises an hour hand and a minute hand, wherein the current time display region (341) displays a current time in an analog type.

6. The programmable timer according to claim 2, further comprising a current time display region 341 that is disposed at a center of the setting time manipulation button unit (310) and comprises an hour hand and a minute hand, wherein the current time display region (341) displays a current time in an analog type.

7. The programmable timer according to claim 2, wherein the control unit (600) manipulates the buttons having numbers 1 to 12 of the setting time manipulation button unit (310) to select month.

8. The programmable timer according to claim 7, wherein the control unit (600) inputs month when any one of the buttons having numbers 1 to 12 is touched once, and inputs day when the number button is touched two or more times.

9. The programmable timer according to claim 2, wherein a day or days of a week are marked for each of the buttons having numbers 1 to 12 of the setting time manipulation button unit (310) and the control unit (600) manipulates the number buttons 1 to 12 to display a set day of the week on the setting time display unit (330).

10. The programmable timer according to claim 2, wherein the panel unit (300) comprises a time and channel display unit (340) that is disposed in a same direction as the buttons having numbers 1 to 12 to display a channel, and the control unit (600) manipulates the buttons having numbers 1 to 12 to display a set channel on the time and channel display unit (340).

11. The programmable timer according to claim 2, wherein the control unit (600) manipulates the buttons having numbers 1 to 12 to display a set hour and minute on the reservation time display region (342).

12. A reservation time display device that displays a reservation time, the reservation time display device comprising:
a panel unit (300) that comprises a time and channel display unit (340) in which a looped AM reservation time display region (342b) and a looped PM reservation time display region (342c) are arranged on concentric circles; and
a control unit (600) dividing set reservation times into a morning time and an afternoon time, assigning the morning time to the AM reservation time display region (342b), assigning the afternoon time to the PM reservation time display region (342c), and controlling a coloring state of the time and channel display unit (340) to enable each reservation time display region (342b) or (342c) to be colored and displayed by an assigned time.
